(19) United States
(12) Patent Application Publication
(10) Pub. No.: US 2024/0124725 A1
(43) Pub. Date: Apr. 18, 2024

(54) DECORATIVE MATERIAL

(71) Applicant: Dai Nippon Printing Co., Ltd., Tokyo (JP)

(72) Inventors: Yuki Aoyama, Odawara-shi (JP); Takafumi Kaida, Sagamihara-shi (JP); Ryouichi Satou, Aikawa-machi Aiko-gun (JP)

(73) Assignee: Dai Nippon Printing Co., Ltd., Tokyo (JP)

(21) Appl. No.: 18/278,016

(22) PCT Filed: Mar. 2, 2022
(86) PCT No.: PCT/JP2022/008800

§ 371 Date: Aug. 21, 2023

(30) Foreign Application Priority Data
Mar. 31, 2021 (JP) 2021-061737

(51) Int. Cl. C09D 11/037; C09D 11/104; C09D 11/107; C09D 11/50; C09D 11/54

(52) U.S. Cl. CPC C09D 11/037; C09D 11/104; C09D 11/107; C09D 11/50; C09D 11/54

(57) ABSTRACT

Provided is a decorative material having a design with an excellent visual effect. The decorative material has a texture region on a base material in which a plurality of projections independent of each other gather together, wherein the projections comprise a resin binder and bright flaky particles.

### TECHNICAL FIELD

The present disclosure relates to a decorative material.

### BACKGROUND ART

Decorative materials are widely used for surface decoration such as building interiors, construction materials, furniture, fittings, building materials, vehicles, home appliances, bathroom products including modular baths, and kitchen products. Examples of such a decorative material include a decorative material in which paper or a resin sheet printed with a picture pattern is attached onto an adherend base material, and decorative material in which a picture pattern formed by printing on a surface of a metal plate such as a steel plate.

In such a decorative material, a texture (tactile) synchronized with the picture pattern and a luxury design may be imparted by further giving an uneven pattern onto the surface.

As a decorative material having an uneven shape on the surface, an embossed decorative material using an embossed plate in which an uneven shape is formed has been proposed (for example, PTLs 1 and 2). Further, a decorative material in which an uneven pattern is imparted onto the surface of the base material by padding printing has been proposed (for example, PTL 3).

### CITATION LIST

### Patent Literature

PTL 1: JP 2015-193209 A

PTL 2: JP 2017-87544 A

PTL 3: JP 63-17613 B

### SUMMARY OF INVENTION

### Technical Problem

However, as described in PTLs 1 and 2, in the case of imparting a design of an uneven pattern by embossing, an embossed plate is required for each pattern, and therefore there has been a problem that it is costly and difficult to manufacture. Further, the uneven pattern is large, and it is difficult to synchronize the uneven shape with the pattern of the base in embossing, and there has been a problem that it is difficult to impart a high level of design.

In the technique of PTL 3, only a visually monotonous pattern can be formed, and it has been difficult to obtain a decorative material with a three-dimensional effect and a sense of depth.

In view of the aforementioned problems, it is an object of the present disclosure to provide a decorative material having a design with an excellent visual effect.

### Solution to Problem

In order to solve the aforementioned problems, the present disclosure provides [1] to [18] below.
[1] A decorative material comprising a texture region on a base material in which a plurality of projections independent of each other gather together, wherein the projections comprise a resin binder and bright flaky particles.
[2] The decorative material according to [1], wherein the average height of the projections is 10 μm to 60 μm.
[3] The decorative material according to [1] or [2], wherein the average diameter of the circumscribed circles of the projections is 100 μm to 500 μm.
[4] The decorative material according to any one of [1] to [3], wherein the area percentage of the projections in the range of 1 cm square of the texture region is 20% to 70%.
[5] The decorative material according to any one of [1] to [4], wherein when the average diameter of the circumscribed circles of a set of adjacent projections is referred to as dₐᵥₑ, and the distance between the centers of the set of adjacent circumscribed circles is referred to as D, the percentage of sets of adjacent projections satisfying the following relationship of D/dₐᵥₑ is 90% or more of all the sets: 0.5≤D/dₐᵥₑ≤6.0.
[6] The decorative material according to any one of [1] to [5], wherein the shortest distance of the adjacent projections is 5 to 120 μm.
[7] The decorative material according to any one of [1] to [6], wherein the content of the bright flaky particles is 3 parts by mass or more and 40 parts by mass or less with respect to 100 parts by mass of the resin binder.
[8] The decorative material according to any one of [1] to [7], wherein the number of the bright flaky particles in the gap region between the projections is 3 or less per 500 μm².
[9] The decorative material according to any one of [1] to [8], wherein the projections further comprise an organic filler with a particle size of 5 μm or more and 60 μm or less.
[10] The decorative material according to [9], wherein the content of the organic filler is 15 parts by mass or more and 50 parts by mass or less with respect to 100 parts by mass of the resin binder.
[11] The decorative material according to any one of [1] to [10], wherein the projections further comprise an inorganic filler.
[12] The decorative material according to [11], wherein the content of the inorganic filler is 1 part by mass to 40 parts by mass with respect to 100 parts by mass of the resin binder.
[13] The decorative material according to any one of [1] to [12], wherein the bright flaky particles are particles with a coating layer of a metal or metal oxide formed on a flaky glass substrate.
[14] The decorative material according to any one of [1] to [13], wherein the decorative material comprises another region other than the texture region.
[15] The decorative material according to [14], wherein when the 60-degree specular gloss of the texture region is defined as G60A, and the 60-degree specular gloss of the other region is defined as G60B, the ratio G60A/G60B is 0.8 or less.
[16] The decorative material according to any one of [1] to [15], comprising a heaping layer on the base material, wherein the surface of the decorative material in the region with the heaping layer is the texture region.
[17] The decorative material according to any one of [1] to [16], wherein the area percentage of the texture region in the surface of the decorative material is 10% or more and 90% or less.
[18] The decorative material according to any one of [1] to [17], wherein the base material is a metal base material.

### Advantageous Effect of Invention

According to the present disclosure, a decorative material having a design with an excellent visual effect can be obtained.

### BRIEF DESCRIPTION OF DRAWINGS

FIG. 1 is a perspective view of a decorative material according to one embodiment of the present disclosure.

FIG. 2 is a schematic plan view enlarging the region represented by reference numeral R in FIG. 1.

FIG. 3 is a schematic cross-sectional view of parts provided with a texture region in a decorative material according to one embodiment of the present disclosure.

FIG. 4 is a view for explaining each definition of “circumscribed circles of projections”, “diameters of circumscribed circles”, and “distance between centers of a set of adjacent circumscribed circles” in the present disclosure.

FIG. 5 is an appearance image of the decorative material of Example 1.

FIG. 6 is an appearance image of the decorative material of Example 2.

FIG. 7 is a micrograph of a texture region in the decorative material of Example 1.

FIG. 8 is a micrograph of a texture region in the decorative material of Comparative Example 1.

FIG. 9 is a micrograph of a texture region in the decorative material of Comparative Example 2.

### DESCRIPTION OF EMBODIMENTS

Hereinafter, the decorative material of the present disclosure will be described in detail. In this description, the expression of the numerical range “AA to BB” means to be “AA or more and BB or less”.

The decorative material of the present disclosure has a texture region in which a plurality of projections independent of each other gather together on a base material, wherein the projections include a resin binder and bright flaky particles.

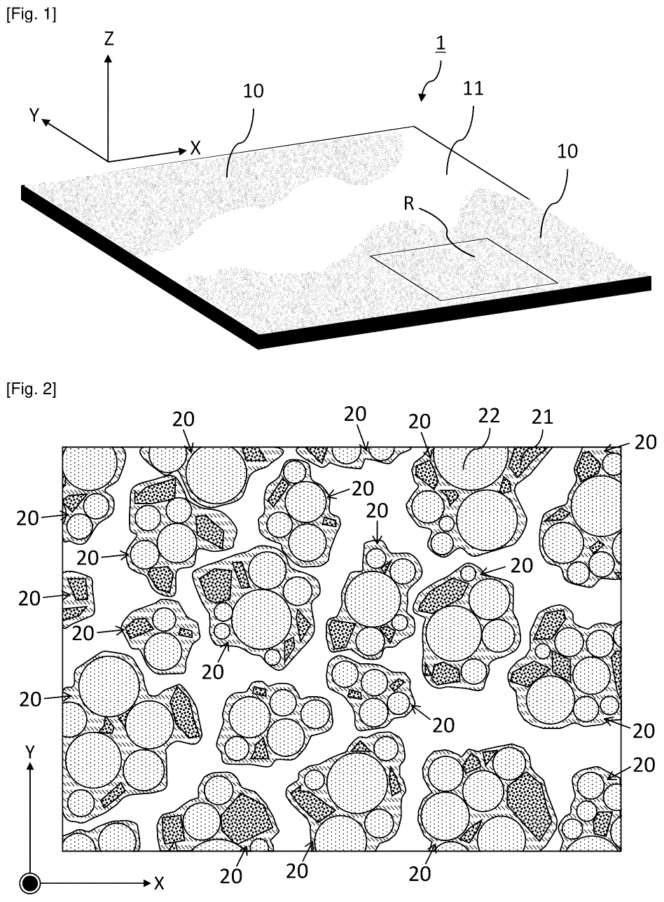

FIG. 1 is a perspective view of a decorative material according to one embodiment of the present disclosure. A decorative material 1 has a visible picture (pattern) when viewed from the front side. The decorative material 1 has a texture region 10 on the front side of the base material in plan view.

The texture region 10 may be provided on the entire surface of the decorative material 1 or may be partially provided. In the present disclosure, a region other than the texture region 10 will be referred to as the other region 11. The texture region 10 can be distinguished from the other region, for example, by the area percentage of the projection regions, which will be described below.

The area percentage of the texture region on the surface of the decorative material is not particularly limited. In order to impart a contrast between the texture region and the other region, the area percentage of the texture region on the surface of the decorative material is preferably 10% or more and 90% or less, more preferably 20% or more and 80% or less, more preferably 30% or more and 70% or less.

In the case where the texture region 10 is partially provided, the texture region 10 may be formed so as to have a pattern corresponding to the design of the decorative material 1 (a stripe pattern, a lattice pattern, a pattern combining geometric shapes such as squares, triangles, circles, and lines, or an irregular pattern which will be described below). Alternatively, it may be formed in a pattern synchronized at least partially with a picture pattern by a pattern layer, which will be described below.

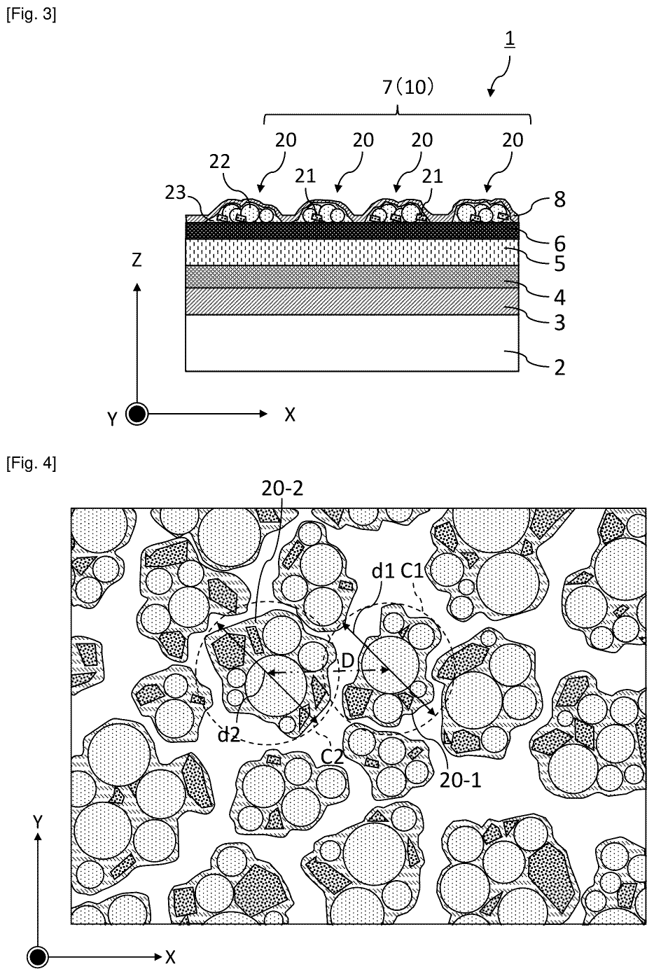

In a cross section (see FIG. 3) of the decorative material cut in the thickness direction, a layer composed of a plurality of projections constituting the texture region is present on at least a part of the base material. In this description, such a layer composed of a plurality of projections may be referred to as a “heaping layer”. That is, the heaping layer is recognized as a layer composed of projections when the texture region is viewed in the Y-axis direction that is orthogonal to the thickness direction of the decorative material (FIG. 3).

In this description, the “plan view” means that the decorative material of the present disclosure is visually recognized in the plane direction from the surface side (front side) on which the texture region is provided. For example, in the XYZ coordinate system shown in FIGS. 1 to 4, the XY plane represented by the X-axis direction and the Y-axis direction substantially is parallel to the surface of the base material, and the “plan view” corresponds to viewing the surface of the base material in the Z-axis direction that is the thickness direction of the decorative material.

### [Texture Region]

FIG. 2 is a schematic plan view enlarging the region represented by reference numeral R in FIG. 1. That is, FIG. 2 is a view in which the texture region is observed in the Z-axis direction of the XYZ coordinate system. The surface as shown in FIG. 2 can be observed by using a microscope such as an optical microscope and a scanning electron microscope.

The texture region can impart a tactile onto the surface of the decorative material.

As shown in FIG. 2, a plurality of projections 20 independent of each other gather together in the texture region. In the texture region, the projections have a gap therebetween. That is, in the texture region of the decorative material of the present disclosure, a plurality of projections 20 that are independent of each other by the gaps gather together. Each projection 20 is a so-called “island region (island part)” having a closed curve contour with a protruding part and a recessed part in plan view. FIG. 2 shows gathering of the irregular projections 20 having a closed curve contour with a protruding part and a recessed part in plan view. The region between the projections 20 constituting the gap is a so-called “sea part” where a transparent underlayer or a pattern layer, which will be described below, is exposed. The presence of the sea part between the island parts allows the projections 20 to be present independent of each other. The structure having the island parts and the sea part in FIG. 2 is also called a sea-island structure. Further, in the structure of FIG. 2, the “sea-island structure” can be referred to also as “phase-separated structure”, the “island part” can be referred to also as “continuous phase”, and the “sea part” can be referred to also as “isolated phase”.

Each “island part” mentioned above is defined as a region having a height of 10 or more when the height is measured in the entire texture region, the maximum height is taken as 100, and the minimum height is taken as 0. Further, the “sea part” mentioned above is defined as a region having such a height of less than 10.

The other regions 11 preferably have no projections.

Each projection 20 may have an irregular or regular shape. The projection 20 preferably has an irregular shape for enhancing a texture as a natural object.

In the present disclosure, an “irregular projection” can be expressed also as a shape having any of the following characteristics.
(1) The geometry where the shapes of the plurality of projections are not all congruent when viewed in plan view, and two or more projections have different shapes and sizes. All of the projections in the texture region may have different shapes and sizes and may include two or more congruent or similar projections.
(2) The case where the shapes of the plurality of projections are different from relatively monotonous shapes such as regular polygons, circles, ellipses, and cardioids (heart shapes) when viewed in plan view. For example, complex shapes in which the contours of the projections need to be approximated by a combination of complex functions such as polynomials and infinite series.
(3) The case where the shapes have the characteristics of both (1) and (2).

### [Projections]

Each of the projections 20 comprises bright flaky particles 21 thereinside. The number of the bright flaky particles contained in one projection 20 is not particularly limited. Meanwhile, the “sea part (gap)” mentioned above is preferably provided with substantially no bright flaky particles. Here, the phrase “with substantially no” means that the number of the bright flaky particles present per 500 μm² area of the sea part is three or less.

Each of the projections 20 preferably comprise a plurality of organic fillers 22 thereinside. The organic fillers 22 are preferably present in the projection 20 in the state where they aggregate in the plane or in the thickness direction, more preferably present in the projection 20 in the state where they aggregate in both the plane and thickness direction. When the projections 20 are viewed in plan view, only one particle is present in a continuous island part of a resin can be present, in addition to a region in which two or more organic fillers aggregate, for example.

FIG. 3 is a schematic cross-sectional view of the part where the texture region 10 is provided in the decorative material according to one embodiment of the present disclosure. That is, FIG. 3 is a schematic cross-sectional view when the texture region of the decorative material shown as an example in FIG. 1 is cut in the Z-axis direction that is the thickness direction of the decorative material. In the texture region of the decorative material 1 of FIG. 3, a primer layer 3, a base coating layer 4, a pattern layer 5, a transparent underlayer 6, a heaping layer 7 (the texture region 10 as viewed in plan view), and a surface coating layer 8 are provided on a base material 2 in this order. A texture region is formed on the surface of the decorative material where the heaping layer 7 is provided. The other region is preferably substantially provided with no heaping layer.

As schematically shown in FIG. 3, in the decorative material 1 according to one embodiment of the present disclosure, the bright flaky particles 21 and the organic fillers 22 of the projection 20 are present on the transparent underlayer 6 (or the pattern layer 5), and the bright flaky particles 21 and the organic fillers 22 are coated with a resin binder 23. In the decorative material 1 of FIG. 3, since the coating with the resin binder is thin, the surface of the projection 20 has an uneven shape roughly following the surface shapes of the bright flaky particles and the organic fillers. That is, the texture region of the decorative material 1 of FIG. 3 includes unevenness (relatively large unevenness) derived from the plurality of projections 20 provided in a pattern and unevenness (relatively small unevenness) derived from the bright flaky particles 21 and the organic fillers 22 on the surface of each projection 20.

In the decorative material 1 of the present disclosure, since the projections comprise bright flaky particles and the sea part (gap) comprises substantially no bright flaky particles, it can be said that the bright flaky particles are unevenly distributed in a fine structure. Therefore, when the texture region is observed, the brightness due to the bright flaky particles can be enhanced, and the brightness contrast between the projections and the sea part (gap) in the texture region can be increased, as compared with the case where the bright flaky particles are substantially uniformly dispersed. Furthermore, the brightness contrast between the texture region and the other region can be increased. Further, when the decorative material is observed while changing the angle, a design in which brightness variations are felt by using the bright flaky particles. The brightness variations by changing the angle can be extremely complicated due to diffusion by the slopes of the projections, so that the visual effect can be extremely enhanced. Further, the unevenness on the surfaces of the projections produce the differences in gloss between the projections and the region with no projections, so that a so-called gloss/matte effect can be given, as described above. Therefore, the decorative material 1 of the present disclosure can express an excellent visual effect, that is, a design with a three-dimensional effect and a sense of depth. Further, the unevenness derived from the projections 20 and the unevenness on the surface of each projection 20 can give an excellent tactile. In particular, the texture region 10 provided in a pattern synchronized at least partially with the picture pattern by the pattern layer, which will be described below, allows an aesthetic appearance and a texture when touched that correspond to the picture pattern to be obtained.

For obtaining an excellent visual effect and an excellent tactile, the average height of the projections 20 is preferably 10 μm to 60 μm, more preferably 15 μm to 45 μm, further preferably 25 μm to 35 μm.

Since the projection 20 has an irregular or regular shape, the size of the projection 20 in plan view (when viewed from the surface) is expressed as the diameter of the circumscribed circle in the present disclosure. FIG. 4 is a schematic plane enlarged view of the texture region and shows the same as FIG. 2. The circumscribed circle of the projection 20-1 is a circle represented by reference numeral C1. The diameter of the circumscribed circle C1 is shown by an arrow represented by reference numeral d1. Likewise, the circumscribed circle of the projection 20-2 is a circle represented by reference numeral C2. The diameter of the circumscribed circle C2 is shown by an arrow represented by reference numeral d2. The average diameter of the circumscribed circles of the projections 20 in the entire texture region is defined as “average diameter d”.

In the present disclosure, the average diameter d of the circumscribed circles of the projections 20 is preferably 100 μm to 500 μm. When the average diameter d is 100 μm or more, the visual effect is easily obtained, and a sufficient tactile can be obtained. By setting the average diameter d to 500 μm or less, the projections are made difficult to be visually perceptible. The average diameter d is more preferably 150 μm to 350 μm, more preferably 200 μm to 250 μm.

When the projections 20 are largely spaced apart from each other, a desired visual effect and a sufficient tactile may not be obtained in some cases. It can be seen from this that the projections 20 are preferably closely arranged to some extent in the texture region.

For the visual effect and tactile, the area percentage of the projections 20 in the texture region of the decorative material of the present disclosure is preferably 20% to 70% in a range of 1 cm square. The range of 1 cm square is defined in consideration of the contact area of a finger when the decorative material is touched. The area percentage is more preferably 30% to 60%, further preferably 40% to 50%. The area percentage of the projections is a value obtained by image analysis with an optical micrograph (300 times) and is an average obtained by measuring 10 points in the texture region.

The area percentage of the gap region in the range of 1 cm square of the texture region is preferably 30% to 80%, more preferably 40% to 70%, further preferably 50% to 60%.

The decorative material of the present embodiment may have another region (region other than the texture region). The other region preferably has a tactile and a gloss different from those of the texture region.

In order to distinguish the tactile between the texture region and the other region, the area percentage of the projection regions in the range of 1 cm square of the other region is preferably less than 20% of region, more preferably 10% or less, more preferably 5% or less, more preferably 3% or less, more preferably 1% or less, more preferably 0%.

The area percentage of the projection regions is a value obtained by image analysis of an optical micrograph (magnification: 300 times) and is an average obtained by measuring 10 points in the other region.

Further, in order to distinguish the tactile between the texture region and the other region, the other region is preferably substantially free from particles with a particle size of 5 μm or more. When the other region is viewed in plan view, the percentage of the area where the particles with a particle size of 5 μm or more are present is preferably 3% or less, more preferably 1% or less, more preferably 0.3% or less, more preferably 0%.

Further, when 60-degree specular gloss of the texture region is defined as G60A, and the 60-degree specular gloss of the other region is defined as G60B, the ratio G60A/G60B is preferably 0.8 or less, more preferably 0.6 or less, more preferably 0.5 or less. Setting the ratio G60A/G60B to such a value can facilitate distinguishing the gloss between the texture region and the other region. The 60-degree specular glosses G60A and G60B are each an average of the measured values at 10 points.

Further, for the visual effect and tactile, when the average diameter of the circumscribed circles of one set of adjacent projections 20 when the entire texture region 10 is viewed in plan view is referred to as dₐᵥₑ, and the distance between the centers of the set of adjacent circumscribed circles is referred to as D, the percentage of sets of adjacent projections with D/dₐᵥₑ satisfying the following relationship is preferably 90% or more of all the sets, in the decorative material of the present disclosure.

0.5≤D/dₐᵥₑ≤56.0

The dₐᵥₑ and D described above will be described with reference to FIG. 4. The diameters of the circumscribed circles of one set of adjacent projections 20-1 and 20-2 are respectively referred to as d1 and d2. Accordingly, dₐᵥₑ=(d1+d2)/2 is satisfied. Further, the distance between the centers D is the distance shown by an arrow of the two-dot broken line in FIG. 4.

A large D/dₐᵥₑ indicates that the distance between the adjacent projections is large, and the projections are sparsely distributed. The upper limit of D/dₐᵥₑ is preferably 5.5, more preferably 5.0, further preferably 4.5. Meanwhile, a smaller D/dₐᵥₑ indicates that the projections are more closely arranged. Meanwhile, in the case where D/dₐᵥₑ<1 is satisfied, the region where parts of adjacent projections overlap each other when viewed in plan view increases depending on the shape of the projections. In particular, the fact that D/dₐᵥₑ is 0 means that the projections geometrically overlap each other to form one region. In order for the two projections to be independent of each other by the gap, the lower limit of D/dₐᵥₑ is preferably 0.5, as described above.

The set of adjacent projections satisfying D/dₐᵥₑ falling within such a range more preferably accounts for 95% or more of all the combinations.

Further, the shortest distance between adjacent projections is preferably 5 μm to 120 μm, more preferably 10 μm to 80 μm, further preferably 20 μm to 60 μm. The shortest distance falling within such a range means that the projections are closely arranged in the texture region, so that a good tactile is easily obtained.

Here, the “adjacent projections” can be defined by Voronoi tessellation of an enlarged plan view of the texture region. Voronoi tessellation is to determine the perpendicular bisectors of adjacent generatrices for a plurality of generatrices distributed in the plane and to divide the plane into cellular regions using the perpendicular bisectors obtained.

Specifically, the centers of the circumscribed circles of the projections and the island parts that are not regarded as the projections are first each determined in the enlarged plan view of the texture region. Then, the texture region is subjected to Voronoi tessellation into cellular regions with the center B of the circumscribed circle of each projection and island part as a “generatrix”. Then, the case where two cellular regions corresponding to arbitrarily extracted projections have a common boundary (Voronoi boundary) is defined as the “projection regions being adjacent to each other”.

The projections 20 can be formed, for example, by using an ink (ink for projections) consisting of a resin composition containing a resin binder and bright flaky particles. In this description, the “ink for projections” may be referred to as “ink for heaping layers”. When the ink for projections (ink for heaping layers) is used to form the projections, a gap is formed between the projections at the same time.

### <Resin Binder>

Preferable examples of the resin binder for the projections 20 include urethane resins, acrylic polyol resins, acrylic resins, ester resins, amide resins, butyral resins, styrene resins, urethane-acrylic copolymers, polycarbonate urethane-acrylic copolymers (urethane-acrylic copolymers derived from a polymer (polycarbonate polyol) having a carbonate bond in the polymer main chain and two or more hydroxyl groups in the terminal and side chains), vinyl chloride-vinyl acetate copolymer resins, vinyl chloride-vinyl acetate-acrylic copolymer resins, chlorinated propylene resins, nitrocellulose resins (nitrocellulose), cellulose acetate resins, and fluorine resins, and these can be used individually or in combination of two or more, for example.

### <Bright Flaky Particles>

Examples of the bright flaky particles include pearl pigments, metal scales, and metal-coated glass scales, and one or more of these can be used. These particles can be mixed with an ink individually or in combination. Among them, pearl pigments are preferable, and pearl pigments using glass base materials are particularly preferable.

The average particle size of the bright flaky particles is preferably 5 μm to 100 μm, more preferably 10 μm to 80 μm, further preferably 20 μm to 60 μm. The average thickness of the bright flaky particles is preferably 0.5 μm to 5 μm.

The particle size means a diameter when the bright flaky particles each is assumed to be a complete sphere. The particle size of the bright flaky particles is a diameter obtained by measurement by known methods such as stokes diameter and light scattering diameter. The thickness of the bright flaky particles is measured by the laser diffraction method.

The bright flaky particles preferably have an aspect ratio of the maximum length of the flat surface portion to the thickness (maximum length/thickness) of 10 or more and 180 or less. The length of the flaky bright particles means the maximum length in the plane direction when the particles are observed with a microscope. The thickness of the flaky bright particles is obtained by dividing a cross-sectional image of the particles obtained by microscopy into a plurality of regions with uniform lengths in the length direction and averaging the measured values of the center thickness of respective regions.

Examples of the pearl pigments using glass substrates specifically include particles with a metal oxide coating layer formed on a flaky glass substrate.

Examples of the glass substrate include scaly glass and glass flakes. Examples of the metal oxide of the coating layer include titanium oxide and iron oxide. The color development of the pigment can be different by changing the material and the film thickness of the coating layer.

Examples of other pearl pigments include a scaly matrix such as mica and aluminum coated with a coating layer consisting of a metal oxide such as titanium dioxide, ferric oxide.

In this way, a pearl pigment is not a metal itself, but is mainly composed of a metal oxide, which is a colorant capable of producing a metallic luster. In the present disclosure, any of a white pearl pigment, an interference pearl pigment, and a colored pearl pigment can be used as the pearl pigment.

The length of the other pearl pigment is preferably 5 μm to 90 μm, more preferably 10 μm to 60 μm. The thickness of the other pearl pigment is preferably 0.5 μm to 50 μm, more preferably 1 μm to 30 μm. The length of the pearl pigment means the maximum length in the plane direction when the pigment is observed with a microscope. The thickness of the pearl pigment is obtained by dividing a cross-sectional image of the pigment obtained by microscopy into a plurality of regions with uniform lengths in the length direction and averaging the measured values of the center thickness of respective regions.

Examples of the material of the metal scales include metals and alloys such as aluminum, gold, silver, brass, titanium, chromium, nickel, nickel chromium, and stainless steel.

The metal-coated glass scales are particles with a coating layer of a metal formed on the surface of flaky glass substrate. Examples of the glass constituting the glass substrate include soda glass, potassium glass, phosphate glass, boron silicate glass, and lead glass. Examples of the metal include metals and alloys such as aluminum, gold, silver, brass, titanium, chromium, nickel, nickel chromium, and stainless steel.

The length of the metal scales or metal-coated glass scales is preferably 2 μm to 90 μm, more preferably 10 μm to 60 μm. The thickness of the metal scales or metal-coated glass scales is preferably 0.5 μm to 50 μm, more preferably 1 μm to 30 μm. The length of the metal scales or metal-coated glass scales means the maximum length in the plane direction when the scales are observed with a microscope. The thickness of the metal scales or metal-coated glass scales is obtained by dividing a cross-sectional image of the scales obtained by microscopy into a plurality of regions with uniform lengths in the length direction and averaging the measured values of the center thickness of respective regions.

For imparting a design with high brightness due to the bright flaky particles and increasing the contrast between the region where the bright flaky particles are present and the region where they are absent, the content of the bright flaky particles is preferably 3 parts by mass or more, more preferably 10 parts by mass or more, further preferably 15 parts by mass or more, with respect to 100 parts by mass of the resin binder. For imparting a design with a matte feeling due to the organic fillers or inorganic filler, which will be described below, it is preferably 40 parts by mass or less, more preferably 30 parts by mass or less, further preferably 20 parts by mass or less, with respect to 100 parts by mass of the resin binder.

The orientation direction of the bright flaky particles 21 in the projections 20 is not particularly limited. When the orientation direction is random, brightness variations are felt when observed while changing the angle of the decorative material 1, and a three-dimensional effect and a sense of depth can be imparted to the design of the decorative material 1, which is preferable. When the projections 20 contain at least any of the organic particles and inorganic filler, the orientation direction of the bright flaky particles can be easily randomized.

### <Organic Fillers>

Examples of the organic fillers include resin fillers such as acrylic resins, urethane resins, nylon resins, polypropylene resins, and urea resins. Among these, acrylic resin fillers are preferable. Since acrylic resin fillers have good heat resistance, the organic fillers are less likely to be embedded in the lower layer after the baking process, making it easier to maintain the height. Further, since acrylic resin fillers are less likely to be embedded in the lower layer, the fillers easily aggregate, making it possible to form the projections easily.

The particle size of the organic fillers is preferably 5 μm or more, more preferably 10 μm or more, further preferably 20 μm or more, for imparting a gloss/matte effect and an appropriate tactile to the decorative material 1. Further, the particle size of the organic fillers is preferably 60 μm or less, more preferably 50 μm or less, further preferably 40 μm or less, in order to prevent the organic fillers from falling off from the decorative material 1 and obtain a visual effect and tactile or the like. In particular, in the case of forming the projections by gravure printing, and the organic fillers are excessively large, the particles cannot enter the cells of the plate, or the number of the particles that enter there is reduced. As a result, it may become difficult to obtain a desired visual effect and tactile, and therefore it is particularly preferable to use organic fillers of the aforementioned particle size.

In this description, the particle sizes of various particles are 50% particle sizes (d50: median diameters) when the particle size distribution measured by the dynamic light scattering method is expressed by volume cumulative distribution.

The content of the organic fillers is preferably 15 parts by mass or more, more preferably 20 parts by mass or more, further preferably 25 parts by mass or more, with respect to 100 parts by mass of the resin binder constituting the projections 20. The content of the organic fillers falling within such a range allows the organic fillers each other to easily aggregate to form the projections. Therefore, an excellent visual effect is also obtained, and a design with a three-dimensional effect and a sense of depth can be obtained. Further, an excellent tactile can be imparted to the decorative material 1. Meanwhile, for reliably bonding the organic fillers with the resin binder to suppress falling off and improving the fluidity of the resin composition to facilitate the forming process, the content of the organic fillers is preferably 50 parts by mass or less, more preferably 45 parts by mass or less, further preferably 40 parts by mass or less, with respect to 100 parts by mass of the resin binder.

### <Inorganic Filler>

The projection 20 may further comprise an inorganic filler. Examples of the inorganic filler include silica, clay, heavy calcium carbonate, light calcium carbonate, precipitated barium sulfate, calcium silicate, and synthetic silicate. The size of the inorganic filler is preferably 1 μm to 20 μm, more preferably 3 μm to 10 μm, further preferably 3 μm to 7 μm. The size of the inorganic filler is preferably determined within the range in which the tactile due to the organic fillers is not impaired.

The content of the inorganic filler is preferably 1 part by mass to 40 parts by mass, more preferably 2 parts by mass to 30 parts by mass, further preferably 3 parts by mass to 25 parts by mass, with respect to 100 parts by mass of the resin binder constituting the projections 20.

Containing the inorganic filler in addition to the bright flaky particles enables the gloss of the decorative material to be adjusted. Further, the difference in gloss between the texture region and the other region is increased, so that a luxury design can be imparted to the decorative material.

The ink for projections (ink for heaping layers) may contain an organic solvent, as needed. The organic solvent to be used is not particularly limited, but it is preferable to appropriately select an organic solvent in consideration of the viscosity of the ink and the evaporation rate of the solvent.

Specifically, when the viscosity coefficient of the solvent is excessively low, the viscosity of the ink decreases, and thus the resin is insufficient even if the aggregates of the bright flaky particles and organic fillers are formed, making it difficult to form the projections. As a result, the bright flaky particles are dispersed in the entire texture region, resulting in a low brightness contrast and a monotonical design. Further, it may be difficult to obtain the gloss/matte effect by the organic fillers and a good tactile. Meanwhile, when a solvent with a high viscosity coefficient is used, the viscosity of the ink increases, and thus the application property tends to deteriorate. Further, in the case of forming projections by gravure printing, individual cells are formed independently, or the organic fillers are embedded in the resin, thereby making it difficult to obtain a good gloss or tactile. Further, when the evaporation rate of the solvent is excessively slow, it is difficult to form large projections, which makes it difficult to obtain a good gloss or tactile.

From the above circumstances, selecting an organic solvent having appropriate viscosity coefficient and evaporation rate enables a decorative material having an excellent gloss or tactile to be obtained easily. The organic solvent may be one type or may be a mixed solvent in which a plurality of types are mixed. Specifically, examples of an organic solvent having a suitable viscosity coefficient for the present disclosure include xylene, cyclohexanone, toluene, methyl isobutyl ketone, butyl acetate, methoxy propyl acetate, and propylene glycol monomethyl ether propionate (Methotate). Examples of a solvent having a high evaporation rate include cyclohexanone. In particular, a mixed solvent of xylene and cyclohexanone (mixed solvent at a weight ratio of 1:1) is preferably used.

The amount of the ink for projections (ink for heaping layers) to be applied after drying is preferably 10 g/m² to 500 g/m².

The projections 20 preferably contain a weathering agent such as an ultraviolet absorber and a light stabilizer, for improving the weather resistance.

Hereinafter, each layer of the decorative material 1 other than the heaping layer 7 will be described in detail.

### [Base Material]

The base material 2 is not particularly limited, as long as it is commonly used as a decorative material. For example, resin base materials, metal base materials, ceramic base material, fibrous base material, woody base materials, or the like can be appropriately selected corresponding to the application. Each of the aforementioned base materials may be used individually or may be a laminate in any combination. In the case where the base material 2 is a laminate, an adhesive layer may be further provided between each two layers of the laminate.

Examples of the resin base materials include those consisting of various synthetic resins. Examples of the synthetic resins include polyethylene resins, polypropylene resins, polymethylpentene resins, polyvinyl chloride resins, polyvinylidene chloride resins, polyvinyl alcohol resins, vinyl chloride-vinyl acetate copolymer resins, ethylene-vinyl acetate copolymer resins, ethylene-vinyl alcohol copolymer resins, polyethylene terephthalate resins, polybutylene terephthalate resins, ethylene glycol-naphthalate-isophthalate copolymer resins, polymethylmethacrylate resins, polyethylmethacrylate resins, polybutyl acrylate resins, polyamide resins typified by nylon 6 or nylon 66, cellulose triacetate resins, cellophane, polystyrene resins, polycarbonate resins, polyarylate resins, and polyimide resins.

Examples of the metal base materials include pure metals consisting of a single metal element such as aluminum, iron, copper, and titanium, and those consisting of alloys such as carbon steel, stainless steel, duralumin, brass, and blue copper containing one or more of these metals. Further, these metals processed by plating or the like can also be used. Since metal base materials have excellent heat resistance, they are resistant to deformation or the like during heat treatment at high temperature (drying process after formation of a base coating layer and the final baking process) in the manufacturing method described later and thus are preferable. Further, use of the metal base material can further enhance the effect of the bright flaky particles by the reflection of the metal base material.

Examples of the ceramic base materials include gypsum boards, calcium silicate plates, ceramic construction materials such as wood cement boards, ceramics, glass, enamel, and baked tiles. Since ceramic base materials also have excellent heat resistance, they are resistant to deformation or the like during heat treatment at high temperature in the manufacturing method described later and thus are preferable.

As a fibrous base material, paper base materials such as thin paper, kraft paper, titanium paper, linter paper, paperboards, and base paper for gypsum boards can be used, for example. These paper base materials may be further supplemented with resins such as acrylic resins, styrene butadiene rubber, melamine resins, urethane resins (resin impregnation after papermaking or filling during papermaking) for enhancing the strength between the fibers of the paper base material or the interlayer strength between another layer and such a paper base material or preventing fluffing. Examples of the paper base material supplemented with resins include inter-paper reinforced paper and resin-impregnated paper.

Further, a vinyl wallpaper raw fabric or the like with a vinyl chloride resin layer provided on the surface of a paper base material also can be used as a fibrous base material.

Further, examples of the fibrous base materials include woven fabrics and non-woven fabrics of various fibers having a paper-like appearance and properties, although they are distinguished from the aforementioned paper base materials. Examples of the various fibers include inorganic fibers such as glass fibers, asbestos fibers, potassium titanate fibers, alumina fibers, silica fibers, and carbon fibers. Further, examples of the various fibers include synthetic resin fibers such as polyester fibers, acrylic fibers, and viniron fibers. The papers are preferably used while being laminated with a plastic base material having excellent excipient suitability in view of the excipient suitability of the uneven pattern.

Examples of the woody base materials include wood veneers such as cedar, cypress, pine, zelkova, oak, and lauan, plywoods, laminated woods, particle boards, and medium-density fiberboards (MDF).

The thickness of the base material 2 is not particularly limited and can be appropriately set according to the application, required specification and the like. For example, the thickness of the base material 2 is preferably 0.02 mm or more and 5 mm or less, more preferably 0.4 mm or more and 3 mm or less.

### [Primer Layer]

The primer layer 3 is provided between the base material 2 and the pattern layer 5. The primer layer 3 serves to ensure good adhesion between the base material 2 and the pattern layer 5.

An ink (ink for primer layers) consisting of a resin composition containing a resin binder is used for forming the primer layer 3. The ink for primer layers may appropriately contain a solvent.

Preferable examples of the resin binder include resins such as urethane resins, acrylic polyol resins, acrylic resins, ester resins, amide resins, butyral resins, styrene resins, urethane-acrylic copolymers, polycarbonate urethane-acrylic copolymers (urethane-acrylic copolymers derived from a polymer (polycarbonate polyol) having a carbonate bond in the polymer main chain and having two or more hydroxyl groups in the terminal and side chains), vinyl chloride-vinyl acetate copolymer resins, vinyl chloride-vinyl acetate-acrylic copolymer resins, chlorinated propylene resins, nitrocellulose resins (nitrocellulose), cellulose acetate resins, and fluorine resins, and these can be used individually or in combination of two or more.

In addition to one-component curable resins, resins of various types including two-component curable resins with a curing agent such as isocyanate compounds, e.g., tolylene diisocyanate (TDI), diphenylmethane diisocyanate (MDI), hexamethylene diisocyanate (HDI), isophorone diisocyanate (IPID), and xylylene diisocyanate (XDI) can be used.

For improving the weather resistance, the primer layer 3 preferably contains a weathering agent such as an ultraviolet absorber and a light stabilizer.

For improving the adhesion between layers or the like, the thickness of the primer layer 3 is preferably 1 μm or more, more preferably 2 μm or more. Further, the upper limit of the thickness of the primer layer 3 is preferably 10 μm or less, more preferably 7 μm or less, further preferably 5 μm or less.

### [Base Coating Layer]

The base coating layer 4 is a layer provided between a substrate 2 and the surface coating layer 8, as required, for enhancing the design.

The base coating layer 4 is generally formed as an opaque layer and serves to impart an intended color and hide the substrate 2 when viewed from a viewer. However, a semi-transparent layer or a transparent layer may be formed as the base coating layer 4, and the pattern or the color of the substrate 2 may be utilized.

For forming the base coating layer 4, an ink consisting of a resin composition (ink for base coating layers) is used. The ink for base coating layers may appropriately contain a solvent.

The resin to be used for forming the base coating layer 4 is not particularly limited. Examples thereof include thermoplastic resins such as fluororesins, (meth)acrylic resins, polyurethane resins, polyester resins, polyamide resins, (meth)acrylic acid ester-olefin copolymer resins, vinyl chloride-acetate resins, ethylene-vinyl acetate copolymer resins (EVA resins), ionomer resins, and olefin-α olefin copolymer resins; and curable resins such as fluororesins, epoxy resins, phenolic resins, urea resins, polyester resins, melamine resins, alkyd resins, polyimide resins, silicone resins, hydroxyl functional acrylic resins, carboxyl functional acrylic resins, amide functional copolymers, and urethane resins. The curable resins include thermosetting resins, ionizing radiation curable resins, and two-component curable resins.

Further, in the case of providing the base coating layer 4 as a hiding layer, the base coating layer 4 contains colorants such as pigments together with the aforementioned resins.

The colorants to be contained in the base coating layer 4 are not particularly limited. Examples thereof include inorganic pigments such as carbon black, iron black, titanium white, antimony white, titanium yellow, yellow iron, red iron oxide (Bengala), cadmium red, ultramarine, and cobalt blue; organic pigments or dyes such as quinacridone red, isoindolinone yellow, and phthalocyanine blue; metallic pigments consisting of scaly foil pieces such as aluminum and brass; and pearl pigments consisting of scaly foil pieces such as titanium dioxide-coated mica and basic lead carbonate. These colorants may be used individually or in combination of two or more.

The base coating layer 4 may contain various additives according to the desired physical properties in addition to the aforementioned components. Examples of the additives include weather resistance improvers such as ultraviolet absorbers and light stabilizers, abrasion resistance improvers, polymerization inhibitors, infrared absorbers, defoamers, and fillers. Further, in the case of using a curable resin for forming the base coating layer 4, a curing agent may be contained. Such an additive may be appropriately selected from those commonly used for use.

The thickness of the base coating layer 4 is not particularly limited and can be appropriately set according to the application and required specification. For example, the thickness of the base coating layer 4 is preferably 5 μm to 40 μm, preferably 10 μm to 30 μm.

### [Pattern Layer]

The pattern layer 5 is provided on the front side of the base material 2, and is a layer imparting a design to the decorative material. The pattern layer 5 may be provided on the entire surface of the base material 2 when viewed from the front side or may be partially provided.

The pattern of the pattern layer 5 is not particularly limited and a desired pattern can be employed. Examples thereof include grain patterns, marble patterns (for example, travertine marble patterns), stone patterns imitating the surface of rocks such as cleavage surfaces of granite plates, cloth patterns imitating cloth textures and cloth-like patterns, leather (leather grain) patterns expressing leather grains, tile patterns, brick patterns, hairlines, hatching grooves, satin-finished surfaces, sand grains, characters, symbols, and geometric patterns, and patterns of wooden mosaic and patchworks combining these.

The pattern layer 5 may have a single-layer structure or a structure in which a plurality of layers are laminated. For example, the pattern layer 5 may have a structure in which the layer on the base material side may be used as a base coating layer to be the basic color, and a pattern layer to serve as a picture pattern may be laminated on the base coating layer.

An ink (ink for pattern layers) consisting of a resin composition containing a resin binder and colorants is used for forming the pattern layer 5. The ink may appropriately contain a solvent.

Preferable examples of the resin binder include resins such as urethane resins, acrylic polyol resins, acrylic resins, polyester resins, alkyd resins, amide resins, butyral resins, styrene resins, urethane-acrylic copolymers, vinyl chloride-vinyl acetate copolymer resins, vinyl chloride-vinyl acetate-acrylic copolymer resins, nitrocellulose resins (nitrocellulose), cellulose acetate resins, and fluororesins. Further, curable resins such as a two-component curable resin containing polyol as a base resin and isocyanate as a curing agent may be used, for example. These can be used individually or in combination of two or more.

Pigments, dyes, and combinations of these can be used as colorants to be used for the pattern layer 5. Examples of the pigments include inorganic pigments such as white pigments, e.g., titanium white, iron black, chrome yellow, titanium yellow, red iron oxide (Bengala), cadmium red, ultramarine, and cobalt blue; organic pigments or dyes such as quinacridone red, isoindolinone yellow, phthalocyanine blue, nickel-azo complexes, azomethine azo black pigments, and perylene black pigments; metal pigments consisting of scaly foil pieces such as aluminum and brass; and pearlescent (pearl) pigments consisting of scaly foil pieces such as titanium dioxide-coated mica and basic lead carbonate.

The pattern layer 5 may contain a weathering agent such as an ultraviolet absorber and a light stabilizer for improving the weather resistance.

The pattern layer 5 may contain a matting agent for easily obtaining a visual effect due to the gloss difference from the projections 20. Examples of the matting agent include organic fillers such as urethane resins, nylon resins, polypropylene resins, or urea resins; and inorganic fillers such as silica, clay, heavy calcium carbonate, light calcium carbonate, precipitated barium sulfate, calcium silicate, and synthetic silicate.

The particle size (volume-average particle size) of the matting agent is preferably 1 μm to 15 μm, more preferably 2 μm to 10 μm, further preferably 3 μm to 7 μm.

Further, the content of the matting agent with respect to 100 parts by mass of the resin binder in the pattern layer is preferably 3 parts by mass or more, more preferably 10 parts by mass or more, further preferably 20 parts by mass or more, and the upper limit is generally 100 parts by mass or less, preferably 70 parts by mass or less, more preferably 50 parts by mass or less, further preferably 30 parts by mass or less. The content of the matting agent falling within such a range can enhance the visual effect (gloss/matte effect) since it enables the pattern layer to be visually recognized as a layer with low gloss.

The thickness of the pattern layer 5 may be appropriately selected according to the desired pattern. The thickness of the pattern layer 5 is preferably 1 μm or more, more preferably 3 μm or more, further preferably 5 μm or more. The upper limit of the thickness of the pattern layer 5 is preferably 10 μm or less, more preferably 7 μm or less, further preferably 5 μm or less. In the case of forming the pattern layer using a plurality of layers, the total thickness of all layers is set to fall within such a range.

### [Transparent Underlayer]

The transparent underlayer 6 is provided between the pattern layer 5 and the projections 20, so as to make the pattern layer 5 easily visible and improving the adhesion between the pattern layer 5 and the projections 20. The transparent underlayer 6 may be provided on the entire surface of the base material 2 when viewed from the front side or may be partially provided.

An ink (ink for transparent underlayers) consisting of a resin composition containing a resin binder is used for forming the transparent underlayer 6. The ink for transparent underlayers may appropriately contain a solvent.

Preferable examples of the resin binder include resins such as urethane resins, acrylic polyol resins, acrylic resins, polyester resins, alkyd resins, amide resins, butyral resins, styrene resins, urethane-acrylic copolymers, vinyl chloride-vinyl acetate copolymer resins, vinyl chloride-vinyl acetate-acrylic copolymer resins, nitrocellulose resins (nitrocellulose), cellulose acetate resins, and fluorine resins. Further, curable resins such as a two-component curable resin containing polyol as a base resin and isocyanate as a curing agent may be used, for example. These can be used individually or in combination of two or more.

The transparent underlayer 6 preferably has higher gloss than the projections 20, for improving the visual effect (gloss/matte effect) due to the gloss difference from the projections 20. The transparent underlayer 6 preferably contains a matting agent, as required.

Examples of the matting agent include inorganic fillers such as silica, clay, heavy calcium carbonate, light calcium carbonate, precipitated barium sulfate, calcium silicate, synthetic silicate, and silicic acid fine powder. The volume-average particle size of the matting agent is preferably 1 μm to 20 μm, more preferably 3 μm to 10 μm, further preferably 3 μm to 7 μm.

Further, the content of the matting agent with respect to 100 parts by mass of the resin binder in the transparent underlayer 6 is preferably 1 part by mass or more, more preferably 3 parts by mass or more, further preferably 5 parts by mass or more, and the upper limit is generally 100 parts by mass or less, preferably 80 parts by mass or less, more preferably 50 parts by mass or less, further preferably 30 parts by mass or less. The content of the matting agent falling within such a range enables an excellent visual effect (gloss/matte effect) to be obtained.

The transparent underlayer 6 may contain a weathering agent such as an ultraviolet absorber and a light stabilizer for improving the weather resistance.

The thickness of the transparent underlayer 6 may be appropriately selected according to the desired pattern. The transparent underlayer 6 is preferably 2 μm or more, more preferably 4 μm or more, further preferably 6 μm or more. Further, the upper limit of the thickness is preferably 20 μm or less, more preferably 15 μm or less, further preferably 10 μm or less.

### [Surface Coating Layer]

The surface coating layer 8 may be formed on the outermost surface of the decorative material 1, as required, for improving the resistance such as weather resistance, scratch resistance, abrasion resistance, and stain resistance and the design such as gloss. When forming the surface coating layer 8, the transparent underlayer 6 can be omitted. When a desired resistance or design is expressed even in the geometry where the projections 20 are exposed to the outermost surface, the surface coating layer can be omitted.

In the case of forming the surface coating layer on the heaping layer, the projections of the texture region and the gap can be formed by the heaping layer and the surface coating layer.

An ink (ink for surface coating layers) consisting of a resin composition is used for forming the surface coating layer 8. The ink for surface coating layers may appropriately contain a solvent.

The resin to be used for forming the surface coating layer 8 is not particularly limited. Examples thereof include thermoplastic resins such as (meth)acrylic resins, polyurethane resins, polyester resins, polyamide resins, (meth)acrylic acid ester-olefin copolymer resins, vinyl chloride-acetate resins, ethylene-vinyl acetate copolymer resins (EVA resins), ionomer resins, and olefin-α olefin copolymer resins; epoxy resins, phenolic resins, urea resins, unsaturated polyester resins, melamine resins, alkyd resins, polyimide resins, silicone resins, hydroxyl functional acrylic resins, carboxyl functional acrylic resins, amide functional copolymers, urethane resins, and fluororesins. These resins may be used individually or in combination of two or more.

The surface coating layer 8 may contain various additives according to the desired physical properties. Examples of the additives include weather resistance improvers such as ultraviolet absorbers (e.g., benzotriazole ultraviolet absorbers and triazine ultraviolet absorbers), light stabilizers (e.g., hindered amine radical scavengers), abrasion resistance improvers (e.g., particles of silica, alumina, and kaolinite), polymerization inhibitors, infrared absorbers, defoamers, and fillers.

The thickness of the surface coating layer 8 is preferably 5 μm or more, more preferably 10 μm or more, further preferably 20 μm or more, in order to impart resistance and gloss to the surface of the decorative material 1. Meanwhile, the upper limit of the thickness of the surface coating layer 8 is preferably 40 μm or less, more preferably 35 μm or less, further preferably 30 μm or less, in consideration of the time and energy required for drying and curing the surface coating layer and the material cost.

For example, the decorative material of the present embodiment can be exemplified by the following laminate structures. The symbol “/” means the boundaries between layers.
(1) Base material/primer layer/base coating layer/pattern layer/transparent underlayer/heaping layer/surface coating layer
(2) Base material/primer layer/base coating layer/pattern layer/transparent underlayer/heaping layer
(3) Base material/primer layer/base coating layer/pattern layer/heaping layer/surface coating layer
(4) Base material/primer layer/base coating layer/pattern layer/heaping layer
(5) Base material/heaping layer
(6) Base material/heaping layer/surface coating layer
(7) Base material/primer layer/heaping layer
(8) Base material/primer layer/heaping layer/surface coating layer
(9) Base material/primer layer/pattern layer/heaping layer/surface coating layer

### [Method for Manufacturing Decorative Material]

In the decorative material 1 of the present disclosure, each layer other than the base material is preferably formed by known application.

Hereinafter, a method for manufacturing the decorative material of the present disclosure will be described by way of an example using a metal plate as a base material.

### (1) Primer Layer-Forming Step

An ink for primer layers is applied onto one surface of a metal plate (base material). This step can be omitted.

The ink for primer layers is preferably applied onto the entire surface of the metal plate. Examples of the application method can include roll coating, reverse coating, air spray coating, electrostatic coating, and powder coating.

After the application, the ink is heated and dried at 100° C. to 300° C., to form a primer layer.

### (2) Base Coating Layer-Forming Step

An ink for base coating layers is applied onto the primer layer. This step can be omitted.

The ink for base coating layers is preferably applied onto the entire surface of the primer layer. Examples of the application method can include flow coater coating, roll coating, reverse coating, air spray coating, electrostatic coating, and powder coating.

After the application, drying is performed under the condition at a heating temperature (temperature of the base material reached) of 165° C. to 270° C. (preferably 200° C. to 250° C.). This allows a base coating layer to be formed.

The lower layers of the projections 20 are suppressed from recessing due to baking after formation of the projections 20 in the part where the organic fillers are present by thermosetting the base coating layer ink within such a temperature range, thereby making it easy to form the projections 20 having sufficient heights. Further, the particles of the projections 20 easily aggregate during heating after formation of the projections 20. As a result, a decorative material having a desired visual effect and a good tactile can be obtained. In particular, in the case of the base coating layer of a thermosetting polyester resin, heating the base material to a temperature reached of 200° C. or more enables a decorative material having an excellent tactile to be easily obtained.

### (3) Pattern Layer-Forming Step

An ink for pattern layers is applied onto the base coating layer with any pattern. This step can be omitted.

Examples of the application method can include gravure printing, offset printing, flexographic printing, letterpress printing, screen printing, ink jet printing, and transfer printing.

After the application, the ink for pattern layers is dried, to form a pattern layer.

### (4) Transparent Underlayer-Forming Step

An ink for transparent underlayers is applied onto the pattern layer. This step can be omitted.

The ink for transparent underlayers is preferably applied onto the entire surface of the metal plate. Examples of the application method can include gravure printing, offset printing, flexographic printing, letterpress printing, and screen printing.

After the application, the ink is heated and dried at 150° C. to 250° C. (temperature of the base material reached), to form a transparent underlayer.

### (5) Heaping Layer-Forming Step

A heaping layer is formed in the region of the decorative material that serves as the texture region. The heaping layer forms the texture region having a plurality of projections independent of each other and further forms a gap between the projections.

Specifically, an ink for projections (ink for heaping layers) is applied onto the transparent underlayer or the pattern layer. The ink for heaping layers may be applied onto the entire surface of the metal plate or may be partially applied thereto. In particular, it is particularly preferable to apply the ink corresponding to the pattern of the pattern layer since an aesthetic appearance and a tactile corresponding to the pattern are obtained.

In the present disclosure, the ink for heaping layers is preferably applied by gravure printing. A gravure printing plate has a plurality of cells on a surface. Immediately after printing, the cell-shaped ink printed from the individual cells on the base material side is independent of each other, but the inks in the form of the plurality of cells are integrated at random partially in the texture region during the process from printing to drying, to form projections. Among the gravure printing, gravure offset printing is particularly preferable since integration of the inks in the form of adjacent cells easily proceeds on a rubber cylinder. In this step, projections may be formed by printing once or may be formed by printing multiple times.

Further, the ink for heaping layers containing an organic solvent having an appropriate viscosity coefficient and an appropriate evaporation rate enables the inks in the form of adjacent cells to be easily integrated. However, if the inks have an excessively low viscosity, the integration becomes less likely to occur, and thus it is preferable to set the content of the particles to fall within the aforementioned range or to select the solvent as described above, for example.

### (6) Surface Coating Layer-Forming Step

An ink for surface coating layers is applied onto the heaping layer. This step can be omitted.

The ink for surface coating layers is preferably applied onto the entire surface of the decorative material. Examples of the application method can include flow coater coating, roll coating, reverse coating, air spray coating, electrostatic coating, and powder coating.

After the application, the ink is heated and dried at 100° C. to 300° C., to form a surface coating layer.

### (7) Baking Step

After the formation of the heaping layer or the surface coating layer, baking is performed under the condition at a heating temperature (temperature of the base material reached) of 150° C. to 270° C. (preferably 200° C. to 250° C.).

### [Laminate]

The laminate of the present disclosure comprises an adherend and the aforementioned decorative material of the present disclosure laminated on the adherend. The adherend and the decorative material are preferably fixed with an adhesive layer, tacks, or the like.

The adherend can be appropriately selected corresponding to the application of the laminate. Examples of the adherend include metal materials, wood materials, ceramic materials, and resin materials.

### [Applications of Decorative Material and Laminate]

The decorative material and laminate of the present disclosure can be used, for example, as a surface decorative board of interior materials or exterior materials.

Examples of the interior materials include surface materials of interior building materials such as walls, floors, and ceilings; surface materials of interior fittings such as partitions, doors, window frames, handrails, surrounding edges, and modular baths; interior materials of vehicles such as cars and electric trains; and surface materials of home appliances.

Examples of the exterior materials include surface materials of exterior building materials such as roofs, walls, floors, balcony blindfolds, space under the eaves, and ceilings; surface materials of exterior fittings such as entrance doors, doors, window frames, handrails, surrounding edges, and moldings; and exterior materials of vehicles such as cars and electric trains.

### EXAMPLES

Then, the present disclosure will be described further in detail by way of examples, but the present disclosure is not limited by these examples at all.

### [Measurement and Evaluation]

The decorative materials produced in Examples and Comparative Examples were measured and evaluated as follows. Table 1 shows the results.

### <Appearance Observation>

The appearance of the decorative materials of Examples and Comparative Examples was observed.

### <Visual Effect Evaluation>

The decorative materials of Examples and Comparative Examples were evaluated for the visual effect such as brightness and a three-dimensional effect. Twenty human subjects were subjected to evaluation. Those that made them to feel to have an excellent visual effect were evaluated as 2 points, those that made them to feel to have a visual effect but it is insufficient were evaluated as 1 point, and those that made them to feel to have a poor visual effect were evaluated as 0 point, to calculate each average point. According to the average point obtained, evaluation was made using the following indices.
A: Those with an average point of 1.5 or more
B: Those with an average point of 1.2 or more and less than 1.5
C: Those with an average point of less than 1.2
   <Observation with Optical Microscope (Fine Shape of Texture Region)>

The texture region of the decorative material produced was observed with an optical microscope (digital microscope VHX-2000, available from KEYENCE) under the condition at a magnification of 200 to 700 times.

### <Calculation of Area Percentage>

Each of the decorative materials of Examples and Comparative Examples were binarized using the optical microscope image described above (magnification: 300 times). Projections were extracted from the image after the binarization, to calculate the area percentage of the projections with respect to the entire image.

### <Average Diameter of Circumscribed Circles>

For each of the decorative materials of Examples and Comparative Examples, the diameters of the circumscribed circles of all the projections that can be observed in the image after the binarization were calculated. Further, the average diameter of the circumscribed circles obtained (average diameter) was calculated.

### <D/dₐᵥₑ>

For each of the decorative materials of Examples and Comparative Examples, five sets of adjacent projections were selected using the optical microscope image (magnification: 300 times) described above. For each set, the average dₐᵥₑ of the diameters of the circumscribed circles and the distance D between the centers of the circumscribed circles were calculated, to obtain D/dₐᵥₑ. Further, the average of the D/dₐᵥₑ obtained was calculated.

### <Heights (Average Height) of Projections>

For each of the decorative materials of Examples and Comparative Examples, the optical microscope image (magnification: 700 times) described above was analyzed by high-quality depth synthesis 3D, to measure the average height of the projections. The average height was determined from the heights of the projections by drawing four lines each passing through the center of the circumscribed circle of the projection on the four lines to divide the circumscribed circle into eight equal parts and averaging the heights from the region where no projection was present.

### <Tactile>

The texture region of each decorative material produced was checked by finger touch. Twenty human subjects were subjected to evaluation. Those that made them to strongly feel unevenness were evaluated as 2 points, those that made them to feel unevenness were evaluated as 1 point, and those that made them to hardly feel unevenness were evaluated as 0 points, to calculate each average point. According to the average point obtained, evaluation was made using the following indices.
A: Those with an average point of 1.5 or more
B: Those with an average point of 1.2 or more and less than 1.5
C: Those with an average point of less than 1.2

### Example 1

An ink for primer layers prescribed as follows was applied onto the entire surface of a steel plate (SGCC-QM, size: 800 mm×2000 mm, thickness: 0.6 mm) by roll coating so that the film thickness after drying was 2 μm. Thereafter, it was dried at 230° C. (temperature of the base material reached) to form a primer layer.

### <Ink for Primer Layers>

Thermosetting polyester resin
Dilute solvent
Solid content: 74 mass %

The ink for base coating layers prescribed as follows was applied onto the entire surface of the primer layer using a curtain flow coater so that the film thickness after drying was 22 μm. Thereafter, it was dried at 210° C. (temperature of the base material reached) to form a base coating layer.

### <Ink for Base Coating Layers>

Thermosetting polyester resin: 100 parts by mass
Colorants (carbon black, titanium oxide (titanium white), iron oxide (red iron oxide (Bengala)), and yellow iron oxide (yellow iron)): 25 parts by mass
Solvent (xylene and cyclohexanone)
Solid content: 35 mass %

A pattern layer with a predetermined pattern was formed on the base coating layer. Specifically, an ink for pattern layers containing a thermosetting polyester resin and colorants was applied onto the entire surface of the base coating layer by gravure printing so that the film thickness after drying was 1 μm. This allowed a pattern layer with a stone pattern to be formed.

An ink for transparent underlayers prescribed as follows was applied onto the entire surface of the pattern layer by gravure offset printing so that the film thickness after drying was 2 μm.

### <Ink for Transparent Underlayers>

Thermosetting acrylic resin: 100 parts by mass
Silica: 8 parts by mass
Solvent (xylene and cyclohexanone)

An ink for heaping layers 1 prescribed as follows was applied onto the entire surface of the transparent underlayer by gravure printing, followed by drying (amount to be applied after drying: 200 g/m²), to form a heaping layer. This allowed a texture region having a plurality of projections independent of each other to be formed on the transparent underlayer. A diagonal digging gravure plate cylinder was used for printing. The gravure plate cylinder used was made from the method in which a photosensitive resist film on the surface of the metal plate material was exposed to a laser beam and then the metal plate material was corroded to form a desired cell pattern.

### <Ink for Heaping Layers 1>

Thermosetting acrylic resin: 100 parts by mass
Bright flaky particles (glass flake 2025PSTM, available from Nippon Sheet Glass Co., Ltd.): 7 parts by mass
Silica: 20 parts by mass
Acrylic beads (30 μm diameter): 20 parts by mass
Solvent (butyl carbitol, xylene, and cyclohexanone)
Solid content: 40 mass %

After formation of the heaping layer, baking was performed under the condition at 220° C. (temperature of the base material reached). Thus, the decorative material of Example 1 was obtained.

### Example 2

An ink for primer layers prescribed as in Example 1 was applied onto the entire surface of an aluminum plate (A3004PH32, size: 800 mm×2000 mm, thickness: 2 mm) by roll coating so that the film thickness after drying was 2 μm. Thereafter, it was dried at 230° C. (temperature of the base material reached) to form a primer layer.

An ink for base coating layers prescribed as in Example 1 was applied onto the entire surface of the primer layer using a curtain flow coater so that the film thickness after drying was 22 μm. Thereafter, it was dried at 210° C. (temperature of the base material reached) to form a base coating layer.

A pattern layer with a predetermined pattern was formed on the base coating layer. An ink for pattern layers containing a thermosetting polyester resin and colorants was applied onto the entire surface of the base coating layer by gravure printing so that the film thickness after drying was 1 μm. This allowed a pattern layer with a stripe pattern to be formed.

The ink for heaping layers 1 was applied onto the pattern layer into a stripe shape by gravure printing, followed by drying (amount to be applied after drying: 250 g/m²), to form a heaping layer. This allowed a texture region having a plurality of projections independent of each other to be formed on the pattern layer. A diagonal digging gravure plate cylinder was used for printing. The gravure plate cylinder used was made from the method in which a photosensitive resist film on the surface of the metal plate material was exposed to a laser beam and then the metal plate material was corroded to form a desired cell pattern.

On the region with a heaping layer and on the region without a heaping layer (that is, over the entire surface of the aluminum plate), an ink for surface coating layers prescribed as follows was applied with a flow coater so that the film thickness after drying was 18 μm. Thereafter, it was baked at 220° C. (temperature of the base material reached) to form a heaping layer and a surface coating layer. Thus, the decorative material of Example 2 was obtained.

### <Ink for Surface Coating Layers>

Thermosetting polyester resin
Solvent (xylene and cyclohexanone)
Solid content: 35 mass %

### Comparative Example 1

On the entire surface of a steel plate (SGCC-QM, size: 800 mm×2000 mm, thickness: 0.6 mm), layers from the primer layer to the transparent underlayer were formed by the same prescription and process as in Example 1.

Thereafter, an ink for heaping layers 2 prescribed as follows was applied onto the entire surface of the transparent underlayer by gravure printing, followed by drying (amount to be applied after drying: 300 g/m²). Thereafter, it was baked at 220° C. (temperature of the base material reached) to form a heaping layer, so that the decorative material of Comparative Example 1 was obtained.

### <Ink for Heaping Layers 2>

Thermosetting acrylic resin: 100 parts by mass
Silica: 8 parts by mass
Solvent (xylene, cyclohexanone)

### Comparative Example 2

On the entire surface of a steel plate (SGCC-QM, size: 800 mm×2000 mm, thickness: 0.6 mm), layers from the primer layer to the transparent underlayer were formed by the same prescription and process as in Example 1.

Thereafter, an ink for heaping layers 3 prescribed as follows was applied by gravure printing, followed by drying (amount to be applied after drying: 250 g/m²). A diagonal digging gravure plate cylinder was used for printing. The gravure plate cylinder used was made from the method in which a photosensitive resist film on the surface of the metal plate material was exposed to a laser beam and then the metal plate material was corroded to form a desired cell pattern. Thereafter, it was baked at 220° C. (temperature of the base material reached) to form a heaping layer, so that the decorative material of Comparative Example 2 was obtained.

### <Ink for Heaping Layers 3>

Thermosetting acrylic resin: 100 parts by mass
Silica: 8 parts by mass
Acrylic beads (30 μm diameter): 20 parts by mass
Solvent (butyl carbitol, xylene, and cyclohexanone)
Solid content: 40 mass %

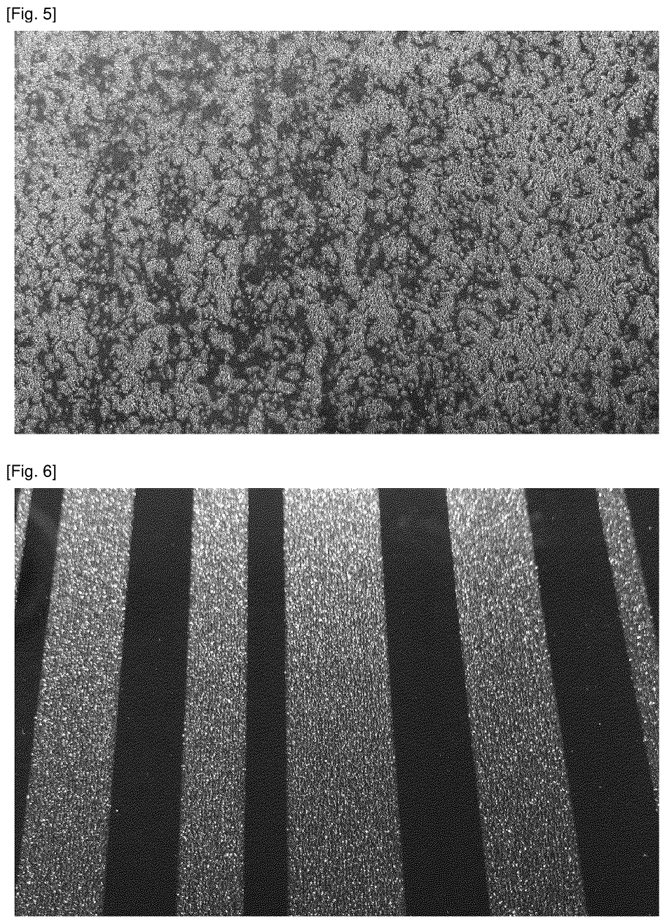

FIG. 5 and FIG. 6 respectively show the appearance images of the decorative materials of Example 1 and Example 2. FIGS. 7 to 9 respectively show micrographs (magnification: 300 times) of the texture regions in the decorative materials of Example 1 and Comparative Examples 1 to 2.

Table 1 shows the evaluation results of the decorative material of each of Examples and Comparative Examples.

TABLE 1

| | | | Comparative | Comparative |
|---|---|---|---|---|
| | Example 1 | Example 2 | Example 1 | Example 2 |
| Average diameter of | 210 | 220 | 70 | 250 |
| circumscribed | | | | |
| circles (μm) | | | | |
| Area percentage (%) | 34 | 30 | 2 | 37 |
| D/dₐᵥₑ | 1.4 | 1.5 | 5.9 | 1.6 |
| Average height (μm) | 23 | 10 | 8 | 20 |
| Visual effect | A | A | C | B |
| Tactile | A | B | C | A |

The decorative material of Example 1 seemed to have a pattern in which the bright flaky particles aggregated and thereby the regions with high brightness were randomly arranged. Therefore, a strong contrast was felt between the regions with high brightness (the regions of the projections in the texture region) and the other region (the region of the sea part in the texture region). Further, when the angle was changed, a design that makes a viewer feel brightness variations in the pattern part was imparted. As a result of this, the decorative material of Example 1 had a three-dimensional effect and could express a design imparting a luxury impression.

In the decorative material of Example 2, the difference in brightness between the texture region (the pattern part with the projections) and the other part (the other region) was significant, and when the angle was changed, brightness variations in the pattern part were felt. Even in the texture region, a contrast was felt between the region where the brightness due to the bright flaky particles was high and the other region. Further, the gloss was suppressed, and a moist texture was felt, in the region other than the bright spots due to the bright flaky particles. As a result, the decorative material of Example 2 could express a design with a three-dimensional effect as a whole.

Further, the decorative materials of Example 1 and Example 2 both were evaluated to have an excellent tactile.

As shown in FIG. 7, it was confirmed that the projections were closely formed in Example 1. Further, the bright flaky particles were unevenly present in the projections (island parts), and the bright flaky particles were hardly found in the region other than the projections (sea part). Due to such a fine structure, it is considered that the brightness of the projections was felt high, and the brightness of the sea part was felt low, resulting in the aforementioned brightness contrast.

In the decorative material of Comparative Example 1, no difference in brightness or gloss was felt between the texture region and the other region. Since no bright flaky particles were contained, the decorative material of Comparative Example 1 failed to express a design with brightness. The decorative material of Comparative Example 1 could express a matting design, which was a design with flat impression. In the decorative material of Comparative Example 1, the tactile due to the texture region was not sensed.

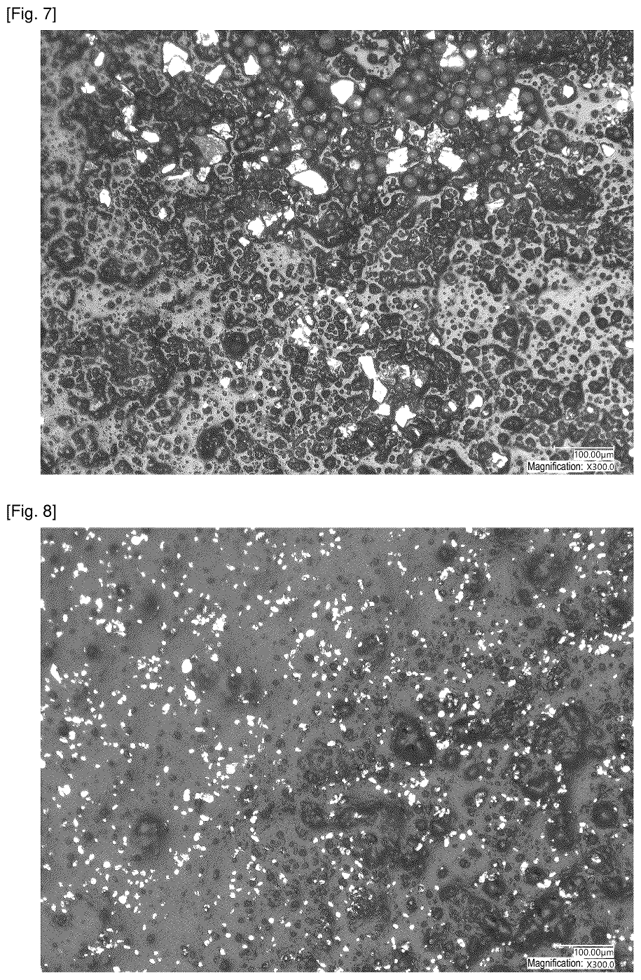

As shown in FIG. 8, although some projections were observed in Comparative Example 1, and they were smaller than in Example 1.

In the decorative material of Comparative Example 2, a difference in gloss between the texture region and the other region was felt, but it could not express a design with brightness as compared with Example 1 and Example 2 since no bright flaky particles were contained. Since the decorative material of Comparative Example 2 contained acrylic beads, a tactile equivalent to Example 1 and Example 2 could be obtained.

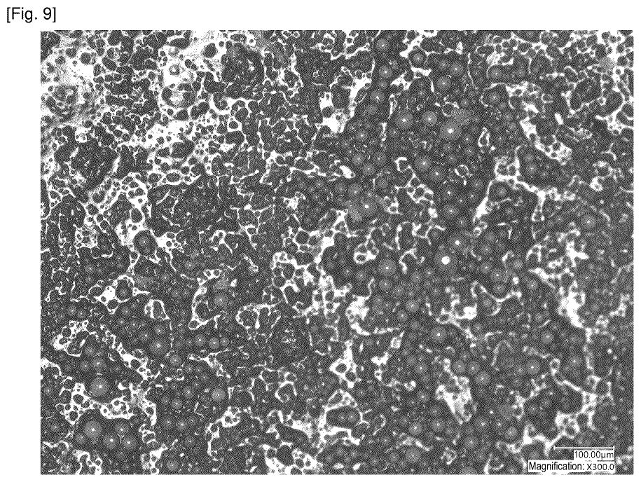

As shown in FIG. 9, it was confirmed that projections formed by aggregation of particles were closely formed in Comparative Example 2.

### REFERENCE SIGNS LIST

1: Decorative material
2: Base material
3: Primer layer
4: Base coating layer
5: Pattern layer
6: Transparent underlayer
7: Heaping layer
8: Surface coating layer
10: Texture region
20: Projections
21: Bright flaky particles
22: Organic fillers
23: Resin binder

1. A decorative material comprising:
a texture region on a base material in which a plurality of projections independent of each other gather together, wherein
the projections comprise a resin binder and bright flaky particles.

2. The decorative material according to claim 1, wherein the average height of the projections is 10 μm to 60 μm.

3. The decorative material according to claim 1, wherein the average diameter of the circumscribed circles of the projections is 100 μm to 500 μm.

4. The decorative material according to claim 1, wherein the area percentage of the projections in the range of 1 cm square of the texture region is 20% to 70%.

5. The decorative material according to claim 1, wherein when the average diameter of the circumscribed circles of a set of adjacent projections is referred to as dₐᵥₑ, and the distance between the centers of the set of adjacent circumscribed circles is referred to as D, the percentage of sets of adjacent projections satisfying the following relationship of D/dₐᵥₑ is 90% or more of all the sets:
0.5≤D/dₐᵥₑ≤6.0.

6. The decorative material according to claim 1, wherein the shortest distance of the adjacent projections is 5 μm to 120 μm.

7. The decorative material according to claim 1, wherein the content of the bright flaky particles is 3 parts by mass or more and 40 parts by mass or less with respect to 100 parts by mass of the resin binder.

8. The decorative material according to claim 1, wherein the number of the bright flaky particles in the gap region between the projections is 3 or less per 500 μm².

9. The decorative material according to claim 1, wherein the projections further comprise an organic filler with a particle size of 5 μm or more and 60 μm or less.

10. The decorative material according to claim 9, wherein the content of the organic filler is 15 parts by mass or more and 50 parts by mass or less with respect to 100 parts by mass of the resin binder.

11. The decorative material according to claim 1, wherein the projections further comprise an inorganic filler.

12. The decorative material according to claim 11, wherein the content of the inorganic filler is 1 part by mass to 40 parts by mass with respect to 100 parts by mass of the resin binder.

13. The decorative material according to claim 1, wherein the bright flaky particles are particles with a coating layer of a metal or metal oxide formed on a flaky glass substrate.

14. The decorative material according to claim 1, wherein the decorative material comprises another region other than the texture region.

15. The decorative material according to claim 14, wherein when the 60-degree specular gloss of the texture region is defined as G60A, and the 60-degree specular gloss of the other region is defined as G60B, the ratio G60A/G60B is 0.8 or less.

16. The decorative material according to claim 1, comprising:
a heaping layer on the base material, wherein the surface of the decorative material in the region with the heaping layer is the texture region.

17. The decorative material according to claim 1, wherein the area percentage of the texture region in the surface of the decorative material is 10% or more and 90% or less.

18. The decorative material according to claim 1, wherein the base material is a metal base material.
